(19) United States
(12) Patent Application Publication
(10) Pub. No.: US 2017/0316486 A1
(43) Pub. Date: Nov. 2, 2017

(54) SYSTEM AND METHOD FOR PRODUCING ITEM SIMILARITIES FROM USAGE DATA

(71) Applicant: Microsoft Technology Licensing, LLC, Redmond, WA (US)

(72) Inventors: Oren Barkan, Rishon-LeZion (IL); Noam Koenigstein, RaAnana (IL); Shay Ben-Elazar, Tel-Aviv (IL); Nir Nice, Kfar-Vradim (IL)

(21) Appl. No.: 15/143,121

(22) Filed: Apr. 29, 2016

(51) Int. Cl. G06Q 30/06; G06F 17/30

(52) U.S. Cl. CPC G06Q 30/0631; G06F 17/30705; G06Q 30/0641

(57) ABSTRACT

A method for producing item recommendations for user consumption from usage data of items as they are consumed in combinations or baskets; breaking the baskets into positive pairs of items appearing in the baskets; finding negative pairs of items appearing relatively frequently in the baskets but not in the positive pairs; embedding all the items of the global catalog or universal set into a latent space such that items appearing together more often in the positive pairs are relatively close together and items appearing together in the negative pairs are relatively far apart; obtaining a selection from a user of a first item for consumption and providing to the user at least one suggestion of a second item for further consumption, the second item not being identical with the first item, the second item being an item located most closely in the latent space to the first item for consumption.

### BACKGROUND

The present invention, in some embodiments thereof, relates to a system for producing similarities from usage data.

Item-based similarities are used by online retailers for recommendations based on a single item. For example, in the Windows 10 App Store, the details page of each app or game includes a list of other similar apps titled “People also like”. This list can be extended to a full page recommendation list of items similar to the original app as shown in FIG. 1. Similar recommendation lists which are based merely on similarities to a single item exist in most online stores e.g., Amazon, Netflix, Google Play, iTunes store and many others.

The single item recommendations are different than the more “traditional” user-to-item recommendations because they are usually shown in the context of an explicit user interest in a specific item and in the context of an explicit user intent to purchase. Therefore, single item recommendations based on item similarities often have higher Click-Through Rates (CTR) than user-to-item recommendations and consequently responsible for a larger share of sales or revenue.

Single item recommendations based on item similarities are used also for a variety of other recommendation tasks: In “candy rank” recommendations a similar item (usually of lower price) is suggested at the check-out page right before the payment. In “bundle” recommendations a set of several items are grouped and recommended together. Finally, item similarities are used in online stores for better exploration and discovery and to improve the overall user experience.

Item similarities can be obtained from item to item data, or from user to item data. There are several scenarios where item-based computer learning methods are desired, without reference to users, for example in a large scale dataset, when the number of users is significantly larger than the number of items, the computational complexity of methods that model items solely is significantly lower than methods that model both users and items simultaneously. For example, online music services may have hundreds of millions of enrolled users with just tens of thousands of artists (items), so that ignoring users and concentrating just on the items considerably reduces complexity.

In certain scenarios, the user-item relations are not available. For instance, a significant portion of today's online shopping is done without an explicit user identification process. Instead, the available information is per session. Treating these sessions as users would be prohibitively expensive as well as less informative.

### SUMMARY

Recent progress in neural embedding methods for linguistic tasks have dramatically advanced state-of-the-art natural language processing (NLP) capabilities. These methods attempt to map words and phrases to a low dimensional vector space that captures semantic relations between the words. Specifically, embedding algorithms, including the algorithm known as Skip-gram with Negative Sampling (SGNS), and developed as Word2Vec, has set new records in various NLP tasks and its applications can be extended to other domains beyond NLP.

The present embodiments may take items that are obtained or consumed in combination with other items, herein baskets, carry out positive and negative sampling on the baskets and use the sampling results to embed the items in the vector space. Recommendations are then provided based on items that are close in the vector space to items already selected by the user. The items and baskets are distinct from the words and sentences for which skip-gram has been used in the past for a number of reasons. Relationships between words and sentences are to do with grammar and semantics, so follow rules that are not intrinsic to the words themselves. However the rules always apply and the only noise in the system is due to the occasional ungrammatical sentence. However an ungrammatical sentence typically violates only one or two rules of grammar and is on the whole grammatical.

Furthermore grammatical errors tend generally to follow rules of their own, so that processing the data is relatively straightforward. By contrast the items coincide in a user's basket due to user's taste, due to user's needs, due to properties of the item and due to pure serendipity. User's tastes and needs may vary, and combine with pure serendipity so that items behave in a way which is very different from words in sentences. There is no extrinsic set of rules to define relationships between items, but merely a statistical connection between the items based on the properties of the item which are in themselves unknown to the algorithm. Such a difference may add a computational complexity which is not present in the traditional uses of Skip-gram.

The present embodiments may be used, not just to make suggestions but also to discover items that have been mislabeled or misassigned.

Unless otherwise defined, all technical and/or scientific terms used herein have the same meaning as commonly understood by one of ordinary skill in the art. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings:

FIG. 1 is a simplified flow chart showing a generalized concept of the present embodiments;

FIG. 2 is an exemplary screen shot showing further items suggested to a consumer after choosing a particular video game;

FIG. 3A is a simplified diagram illustrating embedding of items of music in a latent space according to the present embodiments, wherein color is used to indicate musical genre;

FIG. 3B is a simplified diagram illustrating embedding of items of music according to a comparative method and showing that clustering is less effective;

FIG. 4 is a simplified diagram illustrating how miscategorized items in the catalogue or global database can be identified and even corrected; and

FIG. 5 is a simplified flow chart illustrating negative sampling according to an embodiment.

### DETAILED DESCRIPTION

Consumers of products, literature, music or services or anything that can be consumed in combination, typically make their selections and the selections or baskets are monitored for combinations. Specifically, commonly appearing combinations are noted in a process of positive sampling, and negative sampling looks for combinations which are conspicuous by their absence. The results of the positive and negative sampling together are used to characterize the catalog.

The catalog so categorized is then provided to an embedding algorithm and the items in the catalog are embedded in a latent space based on the sampling so that items often appearing in combination are close together and items rarely or never in combination are far apart.

Later on, users are able to make selections of individual items, and the latent space can be interrogated to find other items close to the selected item in the latent space and provide these as suggestions that may also be of interest.

The embodiments are of particular, but by no means exclusive, application to online stores but are applicable to any situation where consumables are obtained in combination and where data of the item combinations is available so that the sampling and embedding can be carried out.

Before explaining at least one embodiment of the exemplary embodiments in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

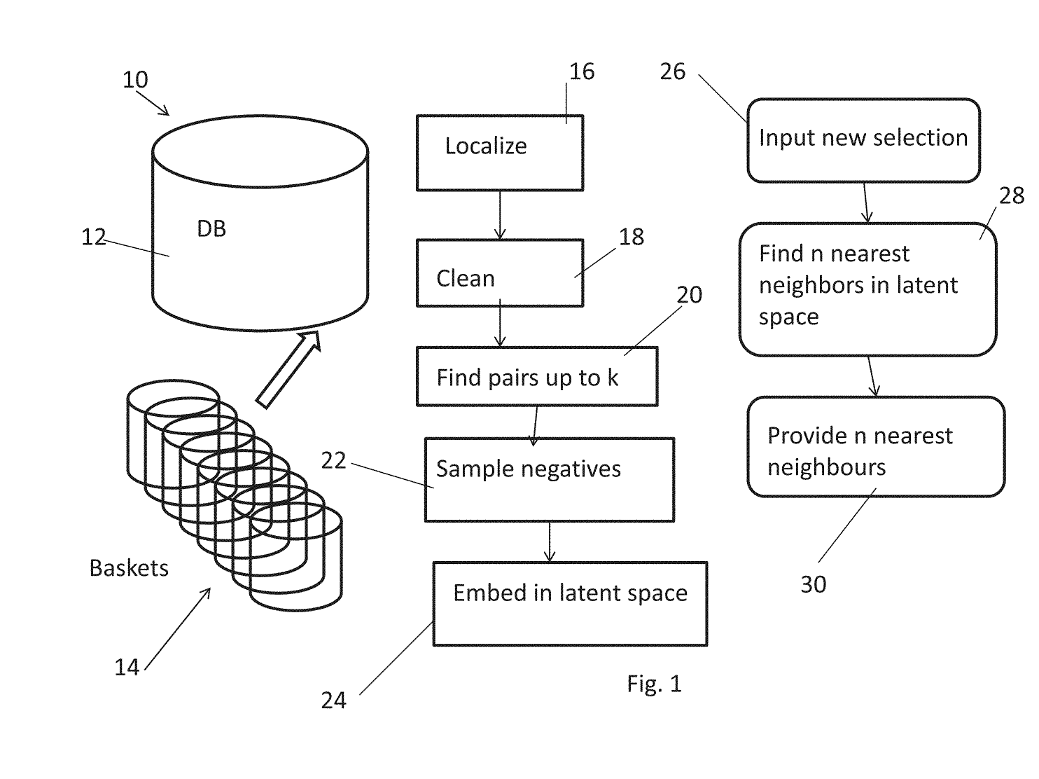

Referring now to the drawings, FIG. 1 is a simplified diagram that illustrates a system for producing item recommendations for user consumption from usage data and providing the recommendations to the user. System 10 comprises a database 12 with a global catalog of products or items. Users obtain the items, say for consumption, and usually the users obtain several items from the catalog in combination in what are referred to herein as baskets 14. Over time the database obtains a large number of such baskets and certain combinations of items are likely to appear more frequently than others. Other combinations of items may be almost or entirely absent.

The system obtains the database of baskets, which may have accumulated over a considerable amount of time. In a stage known as localization 16, each basket considered is broken into a standard size, so as to find positive pairs of items appearing in the basket. The standard size may be based on the size of the global catalog or on the size of the typical basket or on other factors such as computational convenience.

In an optional stage 18 the most popular items in the global database may be removed as these often tend to pair with everything and thus spoil the results. Typically a threshold is set and then items are removed according to a threshold. For example the formula

$$p ( discard \vert w ) = 1 - \sqrt{\frac{ρ}{f ( w )}}$$

may be used to define a frequency above which items are discarded, where f(w) is the frequency of the item w and ρ is the prescribed threshold. Alternatively a preset number n of most popular items may be removed from the catalog.

Now in some cases the order of items is important and in other cases it is not. If the order is not important, then for a basket with ABCDE, AE is just as legitimate a pair as AB or BC. If the order or timing is important then a distance or step limit k can be used—as in box 20. Thus if k=3, then AB at step 1, AC at step 2 and AD at step 3 are considered as pairs but AE is too distant so it is not considered a pair. Localization 16 and setting a step length 18 thus define which of the combinations in the basket are to be considered and provides positive pairs of items as its output.

In stage 22, once all the positive pairs have been found, then it is possible to determine which pairs are conspicuous by their absence. Thus two extremely infrequent items might be absent in combination but being extremely infrequent that is not terribly surprising. On the other hand two particularly popular items being absent in combination is noteworthy. Thus a stage of negative sampling looks for pairs which on average should be expected but do not in fact occur. These are the negative pairs. That is to say, negative sampling looks for pairs of items which individually appear relatively frequently in the baskets but do not appear in the positive pairs. Threshold numbers may be set for the negative pairs.

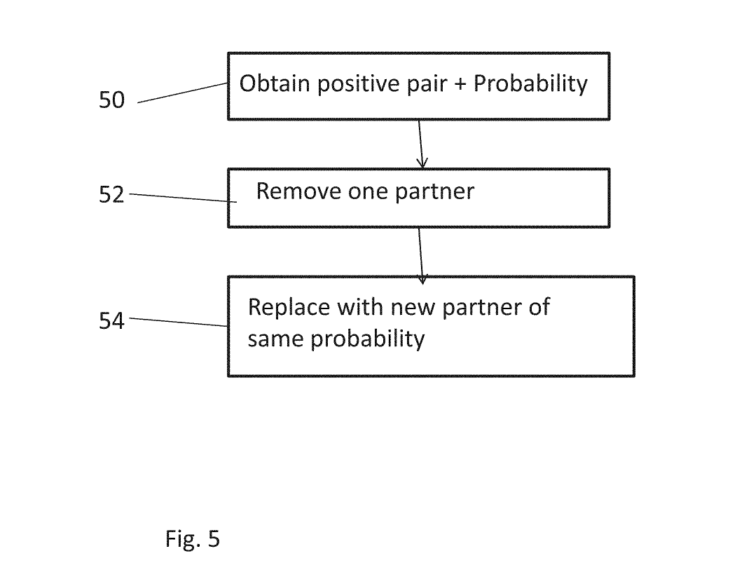

One embodiment carries out the negative sampling as shown in FIG. 5, which is now referenced. The negatives examples are sampled per each positive example 50. For each positive pair, a single item is removed 52 and replaced 54 by a negative item. The negative item is sampled randomly with probabilities proportional to the items prevalence or “popularity” in the positive pairs in the training set. So if ‘A’, ‘B’ and ‘C’ appear in the training set with popularity ratios 50%, 30%, 20%, then the negative items are sampled with the same probabilities. The one other rule is that the negative item may not be the same as the positive item that was removed. That means that if the original pair was “A”+“B”, then when we construct a negative example we may remove “B” and try to find a new pairing for “A”. If that case, we will not choose “B” again because it is the positive item.

The positive pairs and the negative pairs are then provided as constraints for embedding the items of the global catalog into a latent space. The embedding is carried out so that items appearing together more often in the positive pairs are relatively close together and items appearing together in the negative pairs are relatively far apart. The latent space may have any number of dimensions needed to satisfy the constraints. That is it may be required to place A close to B and C, and far away from D and E, while B is to be placed close to A, far from C and close to D. C on the other hand might need to be close to A, far from B, and close to both D and E. D may be required to be far from A, close to B, close to C and distant from E. In order to achieve such a placement it may be necessary to use more than three dimensions, so that the latent space is an n-dimensional space where n is selected to satisfy the constraints.

The embedding process may use skip-gram modeling, as will be discussed in greater detail below.

Having set up the latent space it is now the turn of users to make selections from the catalog or global set. Individual selections are obtained 26 and applied to the latent space where the nearest neighbors are obtained 28. A certain number of nearest neighbors are provided 30 to the user as suggestions to complement the new selection.

As mentioned, the latent space may have several dimensions, and when providing nearest neighbors there may often be a cluster of items in one particular dimension, where the whole cluster is closer than the nearest items in another dimension. In some cases the method may involve providing multiple items from the cluster but in other cases a closest item from the cluster may be sent as representative of the entire cluster, together with closest items from the other dimensions, even though they are further away than other items in the cluster.

The present embodiments may utilize Skip-Gram with negative sampling (SGNS) for item-based CF. Specifically, a modified version of SGNS named item2vec is used, as described herein. The main difference from other advanced recommender system is that the present method produces representation for items provided in combinations. This enables learning of item representation in scenarios where the user-item relations are not available. It is nevertheless still possible to generate a user representation together with the item representation if desired. Most importantly, by removing the users, the present algorithm is optimized to learn items only and may thus achieve superior similarity scores in respect of the items.

An embodiment may thus provide a scalable and efficient algorithm that produces similarity measure between pairs of items based on usage data, since the number of users does nothing more than create new baskets.

An advantage over methods in the existing art is thus the ability to learn item similarities where user profiles are not available.

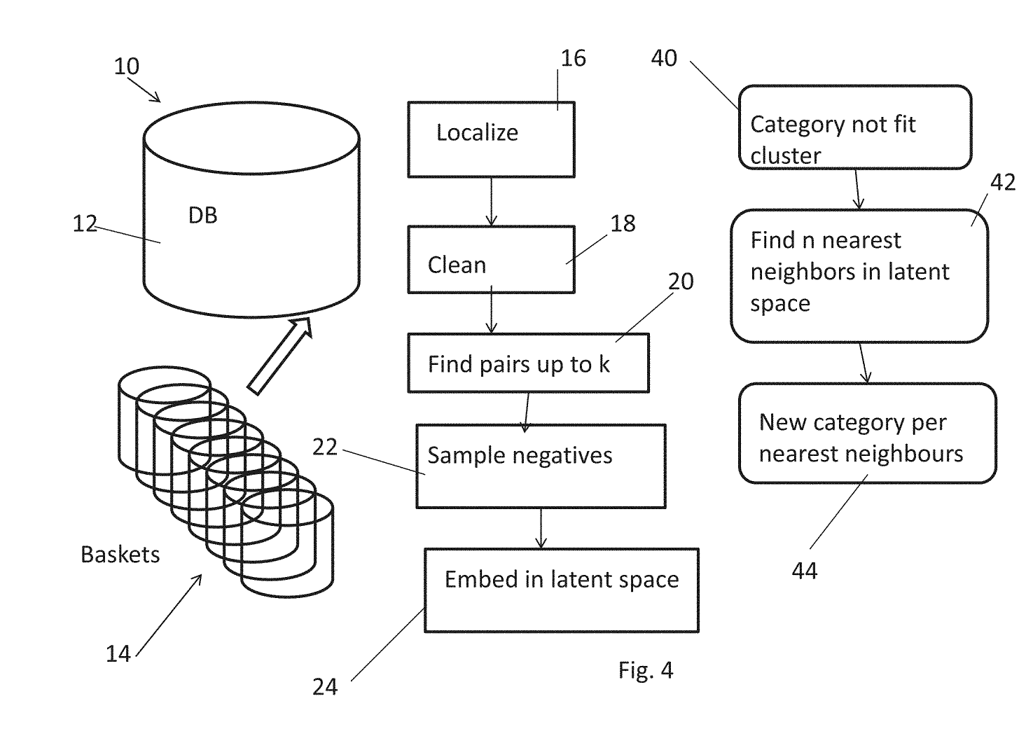

A byproduct of the present method is the ability to trace mislabeled data in a dataset as will be discussed hereinbelow with reference to FIG. 4.

The approach uses the item2vec algorithm as discussed herein, that employs a modified version of SGNS. The main difference from other advanced recommender system is that the present method produces representation for items only. The present embodiments are thus able to learn items representation in scenarios where the user-item relations are not available.

The outline of the item2vec algorithm is as follows: given user generated sets of items, it is possible to learn the items representation by solving an optimization problem. The procedure is iterative and based on stochastic gradient descent. During every iteration, the algorithm samples both positive and negative examples. Each set of items is first filtered by discarding items according to their popularity. Then, positive examples are sampled uniformly and the negative examples are sampled according to their popularity.

The present method is based upon the technique of Skip-gram with negative sampling (SGNS), which is now discussed.

Skip-Gram with Negative Sampling

SGNS is a neural embedding method that was introduced by Mikolov et al. The method aims at finding word representations that capture the relationship between a word and its surrounding words in a sentence.

In the following, we provide a brief overview of the SGNS method.

Given a sequence of words (wᵢ)ᵢ₌₁^{k} from a finite vocabulary W=(wᵢ)ᵢ₌₁^{W}, the Skip-gram objective aims at maximizing the following term:

$$\frac{1}{K} {\sum }_{i = 1}^{K} \sum \text{?} log p ( {w}_{i + j} \vert {w}_{j} ) \\ \text{?} \text{indicates text missing or illegible when filed} \qquad ( 1 )$$

where c is half of the context window size (that may depend on wᵢ) and p(wₐ|w_{b}) is the softmax function:

$$p ( {w}_{a} \vert {w}_{b} ) = \frac{exp ( {v}_{{w}_{a}}^{T} {v}_{{w}_{b}} )}{{\sum }_{w ∈ W} exp ( {v}_{w}^{T} {v}_{{w}_{b}} )} \qquad ( 2 )$$

where m v_{w}ε [symbol] ^{m} is a latent vector that corresponds to the word wεW. The parameter m is chosen empirically and according to the size of the dataset.

The above formulation is impractical due to the computational complexity of ∇p(wₐ|w_{b}), which is a linear function of the vocabulary size W (Typically in a range of 10⁵-10⁶.

Negative sampling comes to alleviate the above computational problem by the replacement of the softmax function from Eq. (2) with

$$p ( {w}_{a} \vert {w}_{b} ) = σ ( {v}_{{w}_{a}}^{T} {v}_{{w}_{b}} ) {\prod }_{i = 1}^{N} {E}_{{w}_{i} \sim {P}_{n} ( w )} [ σ ( - {v}_{{w}_{i}}^{T} {v}_{{w}_{b}} ) ]$$

where σ(x)=1/1+exp(−x), N is a parameter that determines the number of negative examples to be drawn per a positive example and pₙ (w) is the unigram distribution raised to the ¾rd power. This distribution was found to significantly outperform the unigram distribution, empirically.

In order to overcome the imbalance between rare and frequent words the following subsampling procedure is proposed: Given the input word sequence, we discard each word w with a probability

$$p ( discard \vert w ) = 1 - \sqrt{\frac{ρ}{f ( w )}}$$

where f(w) is the frequency of the word w and r is a prescribed threshold. This procedure was reported to accelerate the learning process and to improve the representation of rare words significantly. In experiments carried out by the present inventors it was observed that the same improvements appear when applying subsampling as well.

The latent vectors are then estimated by applying a stochastic optimization with respect to the objective in Eq. (1).

The present method is given with user generated item sets and learns a representation for these items by applying a variant of SGNS that we name item2vec.

### Item2Vec—SGNS for Item-Based CF

In the context of CF data, the items of the global set are given as user generated sets—the baskets. Note that the information about the relation between user and a set of items is not always available. For example, we might be supplied with a dataset that is generated from orders that a store receives, without any information about which identity sent the order. In other words, there are scenarios where multiple sets of items might belong to the same user, but this information is not provided. This is particularly in the case of a physical shop, where customers do not necessarily identify themselves in any way.

The present embodiments apply SGNS to item-based CF. The application of SGNS to CF data is based on the observation that a sequence of words is equivalent to a set of items. Hereinbelow, we use the terms “word” and “item” interchangeably.

By moving from sequences to sets, the spatial/time information is lost. In one embodiment we chose to discard the sequence information since we assume a static environment, where items that belong to the same set are considered similar, no matter in what order/time they were generated by the user. This assumption may not hold in all scenarios.

In the embodiment in which we ignore the spatial information, we treat each pair of items in a set as a positive example. This implies a window size that is determined from the set size. Specifically, for a given set of items, the objective from Eq. (1) is modified as follows:

$$\frac{1}{K} {\sum }_{i = 1}^{K} {\sum }_{j \neq 1}^{K} log p ( {w}_{j} \vert {w}_{i} )$$

The rest of the process remains identical to the algorithm described above. Finally, we compute the affinity between a pair of items by the application of a cosine similarity. We name the described method “Item2Vec”.

Next, we provide a detailed description of the item2vec algorithm.

Item2Vec is designed to find a representation for items that captures the relation between items that share the same user-generated sets, the baskets.

Given a set of items {wᵢ}ᵢ₌₁^{K} from a finite item set W={wᵢ}ᵢ₌₁^{W}, the item2vec objective aims at maximizing the following term:

$$\frac{1}{K} {\sum }_{i = 1}^{K} {\sum }_{j \neq 1}^{K} log p ( {w}_{j} \vert {w}_{i} ) \qquad ( 1 )$$

where p(wₐ|w_{b}) is the softmax function:

$$p ( {w}_{a} \vert {w}_{b} ) = \frac{exp ( {v}_{{w}_{a}}^{T} {v}_{{w}_{b}} )}{{\sum }_{w ∈ W} exp ( {v}_{w}^{T} {v}_{{w}_{b}} )} \qquad ( 2 )$$

where v_{w}ε [symbol] ^{m} is a latent vector that corresponds to the item wεW. The dimension m is chosen empirically and according to the size of the dataset.

The above formulation is impractical due to the computational complexity of ∇p(wₐ|w_{b}) which is a linear function of the item set |W|, that for is usually in size of 10⁴-10⁵.

Negative sampling comes to alleviate the above computational problem by the replacement of the softmax function from Eq. (2) with

$$p ( {w}_{a} \vert {w}_{b} ) = σ ( {v}_{{w}_{a}}^{T} {v}_{{w}_{b}} ) {\prod }_{i = 1}^{N} {E}_{{w}_{i} \sim {P}_{n} ( w )} [ σ ( - {v}_{{w}_{i}}^{T} {v}_{{w}_{b}} ) ]$$

where σ(x)=1/1+exp(−x), N is a parameter that determines the number of negative examples to be drawn per a positive example and pₙ(w) is the unigram distribution raised to the ¾rd.

In order to overcome the imbalance between rare and frequent words the following subsampling procedure is performed: Given the input item set, we discard each item w with a probability

$$p ( discard \vert w ) = 1 - \sqrt{\frac{ρ}{f ( w )}}$$

where f(w) is the frequency of the item w and ρ is a prescribed threshold. This procedure accelerates the learning process and improve the representation of rare items, significantly the latent vectors are then estimated by applying a stochastic optimization with respect to the objective in Eq. (1).

In the following we provide an empirical evaluation of the present method. We provide both qualitative and quantitative results depending whether a metadata about the items is supplied or not. As a baseline item-based CF algorithm we used item-item SVD.

### Datasets

We evaluate our method on two different types of datasets, both private.

The first dataset is user-artist data that is retrieved from the Microsoft XBOX Music service. This dataset consist of 9M events. Each event consists of a user-artist relation, which means the user played a song by the specific artist. The dataset contains 732K users and 49K distinct artists. In addition, each artist is tagged with a distinct genre.

The second dataset contains physical goods orders from Microsoft Store. An order is given by a set of items without any information about the user that made it. Therefore, the information in this dataset is weaker in the sense that we cannot bind between users and items. The dataset consist of 379K orders (that contains more than a single item) and 1706 distinct items.

### Systems and Parameters

The Item2Vec was applied to both datasets. Optimization was done by stochastic gradient decent. The algorithm ran for 20 epochs. A constant for negative sampling was value to N=15 for both datasets. The dimension parameter m was set to 100 and 40 for the Music and Store datasets, respectively. The embodiments also employed subsampling with r values of 5 10- and 3 10- for the Music and Store datasets, respectively. The reason different parameter values were used for each was due to the different sizes of the datasets.

The method was compared to an SVD based item-item similarity system. To this end, we apply SVD to a square matrix in size of number of items, where the (i, j) entry contains the number of times (,) i j w w appears as a positive pair in the dataset. Then, the latent representation is given by the rows of US^{1/2}, where S is a diagonal matrix whose diagonal is the top m singular values and U is a matrix that contains the corresponding left singular vectors as columns. The affinity between items is computed by cosine similarity. Throughout this section we name this method “SVD”.

### Experiments and Results

The music dataset provides genre information per artist. Therefore, we used this information in order to visualize the relation between the learnt representation and the genres. This is motivated by the assumption that a useful representation would cluster artists according to their genre. To this end, we generated a subset that contains the top 100 popular artists per genre for the following distinct genres: ‘R&B/Soul’, ‘Kids’, ‘Classical’, ‘Country’, ‘Electronic/Dance’, ‘Jazz’, ‘Latin’, ‘Hip Hop’, ‘Reggae/Dancehall’, ‘Rock’, ‘World’, ‘Christian/Gospel’ and ‘Blues/Folk’. We applied t-SNE with a cosine kernel to reduce the dimensionality of the item vectors to 2. Then, we colored each artist point according to its genre.

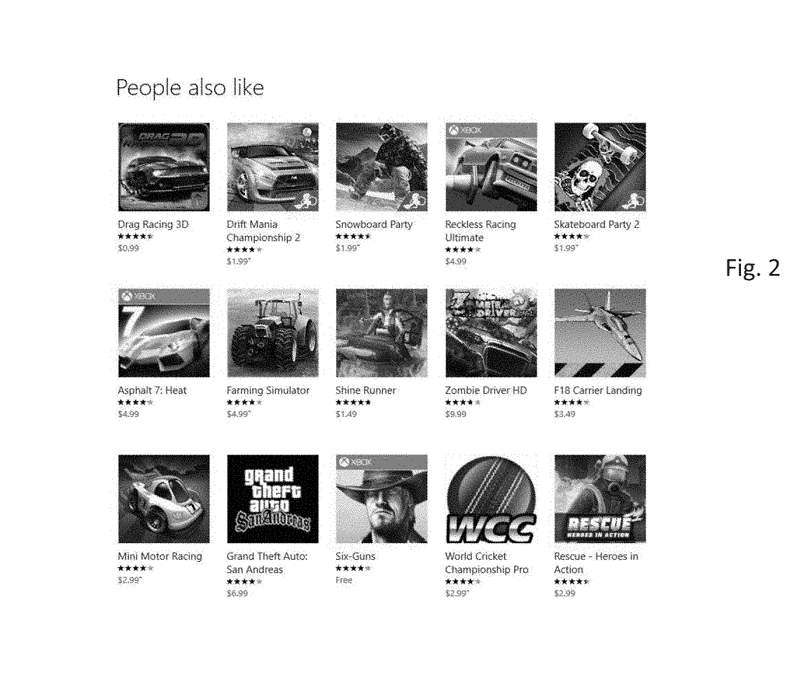

FIG. 2 illustrates an output of fifteen suggestions based on a user selecting the Need for Speed video game.

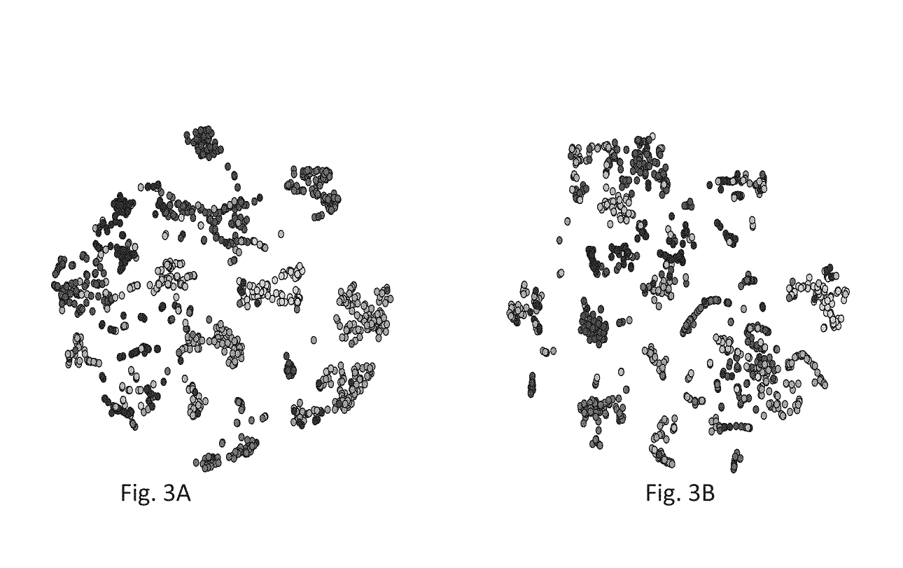

FIG. 3A shows embedding according to the present embodiments and FIG. 3B illustrates 2D embedding using SVD.

From the way in which the colors are grouped it is clear that Item2Vec provides a better clustering. We further observe that some of the relatively homogenous areas in FIG. 3A are contaminated with items that are colored incorrectly or may be marginal members lying between genres.

Investigation showed that many of these cases originate in artists that were mislabeled or have a mixed genre.

Referring now to FIG. 4, the clustering has been carried out and most of the clusters are primarily of the same cluster and some of the clusters are mixtures of two well-represented categories, but there are some odd items that do not fit the cluster in which they are found. In this case, the odd item is identified 40 as not fitting the cluster. In stage 42, the n nearest neighbours are identified where n is an arbitrary number, or a distance may be used instead. The category is then reassigned based on the nearest neighbours to provide the real world result of a catalog that is better categorized.

Although FIG. 4 both identifies the apparent errors and corrects them, an embodiment may simply flag the apparent mistakes for manual correction.

Table 1 presents several examples, where the genre associated with a given artist (according to the catalog) was inaccurate or at least inconsistent with Wikipedia.

Therefore, we conclude that usage based models such as Item2Vec may be useful for the detection of mislabeled data and even provide a suggestion for the correct label using a simple k nearest neighbor (KNN) classifier.

In order to quantify the similarity quality, we tested the genre consistency between an item and its nearest neighbors. We do that by iterating over the top q popular items (for various values of q) and check whether their genre is consistent with the genres of the k nearest items that surround them. This is done by simple majority voting. We ran the same experiment for different neighborhood sizes (k=6, 8, 10, 12 and 16) and no significant change in the results was observed.

Table 2 presents the results obtained for k=8. We observe that Item2Vec is consistently better than the SVD model, where the gap keeps growing as q increases. This might imply that Item2Vec produces a better representation for less popular items than the one produced by SVD, which is unsurprising since Item2Vec subsamples popular items and samples the negative examples according to their popularity.

We further validate this hypothesis by applying the same genre consistency test to a subset of 10K unpopular items, the last row in Table 2 hereinbelow. We define an unpopular item as one that has less than 15 users that played its corresponding artist. The accuracy obtained by Item2Vec was 68%, compared to 58.4% by SVD.

Qualitative comparisons between the Item2Vec and SVD are presented in Tables 3-4 for Music and Store datasets, respectively. The tables present seed items and their 5 nearest neighbors. The main advantage of this comparison is that it enables the inspection of item similarities in higher resolutions than genres.

Moreover, since the Store dataset lacks any informative tags/labels a qualitative evaluation is inevitable. We observe that, for both datasets, Item2Vec provides lists that are more related to the seed item than SVD.

Furthermore, we see that even though the Store dataset contains weaker information, Item2Vec manages to infer about the relations between items quite well.

The present embodiments thus provide Item2Vec as a neural embedding algorithm for item-based collaborative filtering. Item2Vec is based on SGNS with minor modifications. We present both quantitative and qualitative evaluations that demonstrate the effectiveness of Item2Vec when compared to a SVDbased item similarity model. We observe that Item2Vec produces a better representation for items than the one obtained by the baseline SVD-based model, where the gap between the two becomes more significant for unpopular items. We explain this by the fact that Item2Vec employs negative sampling together with subsampling of popular items.

TABLE 1
INCONSISTENCIES BETWEEN GENRES FROM THE CATALOG
TO THE ITEM2VEC BASED KNN PREDICTIONS (K = 8)

| | Genre | |
|---|---|---|
| Genre predicted by Item2Vec based | according | |
| Knn (consistent with Wikipedia) | to catalog | Artist name |
| Hip Hop | R&B/Soul | DMX |
| Hip Hop | Rock/Metal | LLJ |
| Jazz | Blues/Folk | Walter_Beasley |
| Rock/Metal | Hip Hop | Sevendust |
| | Reggae/ | Big Bill Broonzy |
| R&B/Soul | Rock | Anita Baker |
| Jazz | R&B/Soul | Cassandra_Wilson |
| Electronic | Reggae/ | Notixx |
| | Dancehall | |

TABLE 2
A COMPARISON BETWEEN SVD AND ITEM2VEC
ON GENRE CLASSIFICATION TASK FOR VARIOUS
SIZES OF TOP POPULAR ARTIST SETS

| Item2Vec | SVD | Top (q) popular artists |
|---|---|---|
| 86.4% | 85% | 2.5K |
| 84.2% | 83.4 | 5K |
| 82% | 80.2 | 10K |
| 79.5% | 76.8 | 15K |
| 77.9% | 73.8 | 20K |
| 68% | 58.4% | 10K unpopular (see text) |

TABLE 3
A QUALITATIVE COMPARISON BETWEEN ITEM2VEC AND
SVD FOR SELECTED ITEMS FROM THE MUSIC DATASET

| SVD - Top 5 | Item2Vec - Top 5 | Seed item |
|---|---|---|
| JC Chasez - Pop | Rihanna - Pop | Justin |
| Jordan Knight - Pop | Beyonce - Pop | Timberlake - Pop |
| Brothers - Electronic/Dance_{—} | Avicii - Electronic | David Guetta |
| Dance | Calvin Harris - Electronic | Electronic |
| The Blue Rose - | Martin Solveig - Electronic | |
| Electronic/Dance_{—} | Major Lazer - Electronic | |
| Downtempo | Deorro - Electronic | |
| JWJ - Electronic/ | | |
| Dance_Progressive | | |
| Akcent - World_World Pop | | |
| JWC - Electronic/Dance_{—} | | |
| House | | |
| Christina Aguilera - Latin_{—} | Miley Cyrus - Pop | Britney Spears |
| Latin Pop | Lady Gaga | Pop |
| Gwen Stefani - Rock_Indie/ | Pop_Contemporary | |
| Alternative | Pop | |
| Ke$ha - Pop_Contemporary Pop | Christina Aguilera | |
| Jessica Simpson | Latin_Latin | |
| Pop_Contemporary Pop | Pop | |
| Brooke Hogan | P!nk - Pop_{—} | |
| Pop_Contemporary Pop | Contemporary Pop | |
| | Ke$ha - Pop_{—} | |
| | Contemporary Pop | |
| Last Friday Night - | Miley Cyrus | Katy Perry -Pop |
| Electronic/Dance_Dance | Soundtracks_Film | |
| Winx Club - Kids_Kids | Kelly Clarkson - Pop_{—} | |
| Boots On Cats - Rock_Indie | Contemporary Pop | |
| Jack The Smoker - Hip Hop | Game - Pop_Contemporary | Dr. Dre - Hip |
| Royal Goon - Hip Hop | Pop | Hop |
| Hoova Slim - Hip Hop | Snoop Dogg - Hip Hop | |
| Man Power - Electronic | N.W.A - | |
| Dance_Dance | Hip Hop_Contemporary | |
| Ol'Kainry - World_Middle East | Hip Hop | |
| | DMX - R&B/Soul_R&B | |
| | Kendrick Lamar - | |
| | Hip Hop | |
| HANK WILLIAMS | Willie Nelson - Country_{—} | Johnny Cash- |
| Pop_Contemporary Pop | Traditional | Country |
| The Highwaymen - Blues/Folk | Jerry Reed - Country_{—} | |
| Johnny Horton - Pop_{—} | Traditional Country | |
| Contemporary Pop | Dolly Parton | |
| Hoyt Axton - Pop_{—} | Country_Traditional | |
| Contemporary Pop | Country | |
| Willie Nelson - Country_{—} | Merle Haggard - Country_{—} | |
| Traditional Country | Traditional | |
| | HANK WILLIAMS - Pop | |
| Magic Hats - Pop | Kavinsky - Electronic | Daft Punk |
| Contemporary Pop | Breakbeat/Electro | Electronic |
| Modjo - Electronic/ | Fatboy Slim - Electronic | |
| Dance_Dance | Dance_House | |
| Rinrse - Electronic/ | Calvin Harris - Electronic | |
| Dance_Dance | Dance_Dance | |
| Mirwas - Electronic/ | Moby - Electronic | |
| Dance_Dance | Dance_Dance | |
| Playboy - Pop_Contemporary | Chromeo - Electronic | |
| Pop | Dance_Dance | |
| Bon Jovi - Rock_Mainstream | Aerosmith - Rock_Metal & | Guns N' Roses - |
| Rock | Hard Rock | Rock |
| Gilby Clarke - Rock_Indie | Ozzy Osbourne - Rock_{—} | |
| Alternative | Metal & Hard Rock | |
| Def Leppard - Rock_Indie | Bon Jovi - Rock_{—} | |
| Alternative | Mainstream Rock | |
| Motley Crew - Rock_Indie | Motley Crew - Rock_Indie | |
| Alternative | Alternative | |
| Skid Row - Rock_Indie | AC/DC - Rock_Metal & | |
| Alternative | Hard Rock | |
| DJ David - Electronic | Thirty Seconds To Mars - | Linkin Park - |
| Dance_Ambient | Rock_Indie | Rock |
| Little Nicky Soundtrack - Rock | Evanescence - Rock_Indie | |
| Fort Minor - Hip Hop | Alternative | |
| Entspannungsmusik | System Of A Down | |
| Klavier Akademie - World | Rock_Metal | |
| Evanescence - Rock_Indie | Nickelback - Rock_Indie/ | |
| Alternative | Alternative | |
| | Limp Bizkit - Rock_Metal | |
| | & | |
| | Hard Rock | |

TABLE 4
A QUALITATIVE COMPARISON BETWEEN ITEM2VEC AND
SVD FOR SELECTED ITEMS FROM THE STORE DATASET

| SVD - Top 5 | Item2Vec - Top 5 | Seed item |
|---|---|---|
| Minecraft Foam Pickaxe | LEGO Dimensions Bad Cop | LEGO Dimensions Emmet Fun |
| Disney INFINITY Toy Box | Fun Pack | Pack |
| Starter Pack for | LEGO Dimensions Ninjago | |
| Xbox One | Team Pack | |
| Minecraft for Xbox One | LEGO Dimensions The | |
| Terraria for Xbox One | Simpsons: | |
| Dragon Ball Xenoverse for | Bart Fun Pack | |
| Xbox | LEGO Dimensions Gimli Fun | |
| One Full Game | Pack | |
| Download Code | LEGO Dimensions | |
| Rabbids Invasion for Xbox | Minecraft Diamond Earrings | Minecraft |
| One: | Minecraft Periodic Table | Lanyard |
| The Interactive | Minecraft 17-Inch Enderman | |
| TV Show Season | Plush | |
| Pass Download Code | Minecraft Crafting Table | |
| Mortal Kombat X Premium | Minecraft 12-Inch | |
| Edition for Xbox | Skeleton | |
| One Full Game Download | Plush | |
| Code | | |
| Minecraft Periodic Table | | |
| Middle-earth: Shadow of | | |
| Mordor | | |
| PC Game | | |
| Kinect Sensor for Xbox | | |
| NBA Live 14 for Xbox One | Skylanders SWAP Force | Skylanders |
| Watch Dogs Limited Edition | Character - Scorp | SWAP Force |
| PC Game | Skylanders SWAP Force Series | Character - |
| Trials Fusion Season Pass | 3 Character - Heavy Duty | Star Strike |
| Download Code for | Sprocket | |
| Xbox 360 | Skylanders SWAP Force | |
| Minecraft Creeper Face Sticker | Character - Lava Barf Eruptor | |
| Disney INFINITY | Skylanders SWAP Force Series | |
| Figure: Woody | 3 Character - Slobber Tooth | |
| | Skylanders SWAP Force | |
| | Character - Boom Jet | |
| Disney INFINITY 2.0 Figure: | Disney INFINITY 2.0 | Disney INFINITY |
| Disney Originals | Figure: Disney Originals | 2.0 Figure: |
| Stitch | Maleficent | Disney |
| Mega Bloks Halo UNSC | Disney INFINITY 2.0 | Originals Baymax |
| Firebase | Figure: Disney Originals | |
| LEGO Dimensions The | Hiro | |
| Simpsons: Bart Fun Pack | Disney INFINITY 2.0 | |
| Mega Bloks Halo UNSC | Figure: Disney Originals | |
| Gungoose | Stitch | |
| Sid Meier's Civilization: | Disney INFINITY 2.0 | |
| Beyond Earth (PC) | Figure: Marvel Super | |
| | Heroes Nick Fury | |
| | Disney INFINITY 2.0 Marvel | |
| | Super Heroes | |
| | Toy Box Game Discs | |
| Titanfall Collector's Edition | GoPro Anti-Fog Inserts | GoPro LCD |
| For Xbox One | GoPro The Frame Mount | Touch BacPac |
| GoPro The Frame Mount | GoPro HERO3+ | |
| Call of Duty: | Standard Housing | |
| Advanced Warfare | GoPro Floaty Backdoor | |
| Day Zero | GoPro 3-Way | |
| Edition PC Game | | |
| Evolve PC Game | | |
| Total War: Rome 2 | | |
| PC Game | | |
| Thrustmaster TX Racing | Thrustmaster TH8A Add-On | Thrustmaster |
| Wheel Ferrari 458 Italia | Gearbox Shifter | T3PA Pedal Set |
| Edition | Thrustmaster T3PA-PRO 3- | Add-On |
| Tom Clancy's The Division | Pedal Add-On | |
| For Xbox One | Thrustmaster TM Leather 28 | |
| Xbox One Play and Charge | GT Wheel Add- On | |
| Kit | Astro Gaming A40 Headset | |
| Xbox One Chat Headset | for Xbox One | |
| Disney INFINITY 2.0 Figure: | Thrustmaster Ferrari F1 | |
| Disney Originals | Wheel | |
| Tinker Bell | Add-On | |
| Farming Simulator PC Game | UAG Surface Pro 4 Case | Surface Pro 4 |
| Dell Alienware Echo 17 | (Black) Surface Pro 4 | Type Cover with |
| R3 | Type Cover with Fingerprint | Fingerprint ID |
| AW17R3-834SLV Signature | ID (Onyx) | (Onyx) |
| Edition Gaming Laptop | Jack Spade Zip Sleeve for | |
| Bose SoundLink Around- | Surface (Luggage | |
| Ear Wireless | Nylon Navy) | |
| Headphones II | Microsoft Surface 65 W | |
| UAG Surface Pro 4 | Power Supply | |
| Case (Black) | PerfectFit | |
| Microsoft Surface Pro 4 - | Surface | |
| Customize your device | Pro 4 Antimicrobial | |
| | CleanShield Premium Film | |
| | Screen Protection | |
| NBA Live for Xbox One - 4 | Windows Server 2012 | Windows |
| 600 NBA Points | Remote Desktop | Server |
| Download Code | Services 1-User CAL | 2012 R2 |
| Windows 10 Home | Exchange Server 2010 Standard | |
| Mega Bloks Halo Covenant | Edition 64-Bit | |
| Drone Outbreak | 5-Client License | |
| Mega Bloks | Windows Server 2012 5-User | |
| Halo UNSC | Client Access | |
| Vulture Gunship | License | |
| Windows 10 Pro | Exchange Server 2010 | |
| | Standard Edition 5-User | |
| | CAL | |
| | Windows Server 2012 | |
| | Remote Desktop | |
| | Services 5-Device CAL | |

In summary, according to one aspect of the present embodiments there is provided a method for producing item recommendations for user consumption from usage data comprising:

obtaining a database of baskets, the baskets containing items consumed in combination from a global catalog of items;

breaking the baskets into positive pairs of items appearing in the baskets; inding negative pairs of items appearing relatively frequently in the baskets but not in the positive pairs;

embedding items of the global catalog into a latent space such that items appearing together more often in the positive pairs are relatively close together and items appearing together in the negative pairs are relatively far apart;

obtaining a selection from a user of a first item for consumption and providing to the user at least one suggestion of a second item for further consumption, the second item not being identical with the first item, the second item being an item located most closely in the latent space to the first item for consumption.

In an embodiment, the baskets have respective sizes and the method comprises the baskets to sub-baskets of a predetermined size prior to the breaking into positive pairs.

In an embodiment, the items in the catalog include a predetermined number of most frequently consumed items and the method comprises removing the predetermined number of most popular items from the baskets prior to the breaking into positive pairs.

In an embodiment, the items in the catalog comprise most frequently used items and wherein items are removed prior to sampling according to the formula

$$p ( discard \vert w ) = 1 - \sqrt{\frac{ρ}{f ( w )}} .$$

where f(w) is the frequency of the item w and ρ is a prescribed threshold.

In an embodiment, the embedding is carried out using skip gram modeling.

In an embodiment, the embedding comprises using the positive and negative pairs as constraints to define placement of the items in the latent space.

An embodiment may comprise selecting a dimension for the latent space to enable satisfaction of the constraints.

In an embodiment, the embedding is carried out iteratively.

In an embodiment, the iterative embedding comprises stochastic gradient descent.

In an embodiment, during each of a plurality of iterations, the embedding samples both the positive and the negative pairs, the positive pairs being sampled uniformly and the negative pairs being sampled according to a respective popularity.

A second aspect of the present embodiments, may provide a method for finding and correcting mis-categorizations in a catalog of items consumed in combination, the items in the catalog being categorized among a plurality of categories:

obtaining a database of combinations of items as consumed from a global catalog of items;

breaking the combinations into positive pairs of items appearing in the combinations;

finding negative pairs of items appearing relatively frequently in the combinations but not in the positive pairs;

embedding items of the global catalog into a latent space such that items appearing together more often in the positive pairs are relatively close together and items appearing together in the negative pairs are relatively far apart;

looking through the latent space for clustering of items and identifying miscategorized items as items with categorizations that differ from other items with which they are clustered;

recategorizing the miscategorized items based on a majority of nearest neighbours.

Certain features of the examples described herein, which are, for clarity, described in the context of separate embodiments, may also be provided in combination in a single embodiment. Conversely, various features of the examples described herein, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

What is claimed is:

1. A method for producing item recommendations for user consumption from usage data comprising:
obtaining a database of baskets, the baskets containing items consumed in combination from a global catalog of items;
breaking the baskets into positive pairs of items appearing in the baskets;
finding negative pairs of items appearing relatively frequently in the baskets but not in the positive pairs;
embedding items of the global catalog into a latent space such that items appearing together more often in the positive pairs are relatively close together and items appearing together in the negative pairs are relatively far apart;
obtaining a selection from a user of a first item for consumption and providing to the user at least one suggestion of a second item for further consumption, the second item not being identical with the first item, the second item being an item located most closely in the latent space to the first item for consumption.

2. The method of claim 1, wherein the baskets have respective sizes and the method comprises the baskets to sub-baskets of a predetermined size prior to the breaking into positive pairs.

3. The method of claim 2, wherein the items in the catalog include a predetermined number of most frequently consumed items and the method comprises removing the predetermined number of most popular items from the baskets prior to the breaking into positive pairs.

4. The method of claim 2, wherein the items in the catalog comprise most frequently used items and wherein items are removed prior to sampling according to the formula
$$p ( discard \vert w ) = 1 - \sqrt{\frac{ρ}{f ( w )}}$$
where f(w) is the frequency of the item w and ρ is a prescribed threshold.

5. The method of claim 1, wherein the embedding is carried out using skip gram modeling.

6. The method of claim 1, wherein the embedding comprises using the positive and negative pairs as constraints to define placement of the items in the latent space.

7. The method of claim 5, comprising selecting a dimension for the latent space to enable satisfaction of the constraints.

8. The method of claim 1, wherein the embedding is carried out iteratively.

9. The method of claim 8, wherein the iterative embedding comprises stochastic gradient descent.

10. The method of claim 9, wherein during each of a plurality of iterations, the embedding samples both the positive and the negative pairs, the positive pairs being sampled uniformly and the negative pairs being sampled according to a respective popularity.

11. The method of claim 1, wherein the finding negative pairs comprises taking respective positive pairs, removing one item of the positive pair and replacing the removed item with another item having a same probability as the removed item.

12. A method for finding and correcting mis-categorizations in a catalog of items consumed in combination, the items in the catalog being categorized among a plurality of categories:
obtaining a database of combinations of items as consumed from a global catalog of items;
breaking the combinations into positive pairs of items appearing in the combinations;
finding negative pairs of items appearing relatively frequently in the combinations but not in the positive pairs;
embedding items of the global catalog into a latent space such that items appearing together more often in the positive pairs are relatively close together and items appearing together in the negative pairs are relatively far apart;
looking through the latent space for clustering of items and identifying miscategorized items as items with categorizations that differ from other items with which they are clustered;
recategorizing the miscategorized items based on a majority of nearest neighbours.
